(19) United States
(12) Patent Application Publication
(10) Pub. No.: US 2003/0187953 A1
(43) Pub. Date: Oct. 2, 2003

(54) Method of preparing and integrating set programming for the internet

(76) Inventors: Jeffrey J. Pearson, Philadelphia, PA (US); Hayward A. McCain, Philadelphia, PA (US); Damon L. Walden, Philadelphia, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/106,606

(22) Filed: Mar. 26, 2002

(51) Int. Cl. H04N 7/025; H04N 7/10; G06F 15/16

(52) U.S. Cl. 709/219; 725/32

(57) ABSTRACT

Integrating programming media and commercial material for presentation as a composite program of a set length of time for use at a web site on the Internet. Programming and commercial material is captured and defined on a memory device. The programming and commercial material is then encoded with such custom enhancements of the audio and video determined to be desirable for improved quality. The audio and video running time of each portion of the content is adjusted within standard program format. The commercial content is encoded in post processing to match the setting used on programming content. The encoded programming content is split into individual files transmitting finalized content to a distribution server. The finalized content is then arranged into program format consisting of individual program content files interspersed with selected commercial content files using a side server. A play list may be prepared arranging the finalized content into final program format. The system is then prepared for uninterrupted broadcast using the side server play list of programming in predetermined sequence. Then the composite program as sequenced may be made accessible to subscribers at scheduled times at a designated source.

### FIELD OF THE INVENTION

The present invention relates to a process for creating continuous programming for a web site on the Internet for access by the public. Its most probable use would appear to be integrating advertising into a movie to simulate the type of programming of television. Other uses are also possible where programming is desired for regular presentation on the Internet, just as programming is presented in regular format on television. The concept is to have schedules for this programming just as the television programs are scheduled in news papers or magazines.

### BACKGROUND

Due to growing popularity of the Internet, there are many forms of entertainment making an appearance. Movies are shown in 30 second clips with the purposes of inducing subscription to certain channels or to entice viewers to certain television programs or sites. Movies and video clips are offered on demand for a single fee or by the minute. Some production studios and video distributors offer free partial display of a movie, hoping that the consumer will purchase a film or DVD from extended catalog that is presented on their site.

### SUMMARY OF THE INVENTION

The present invention is an extension of what is being done today and is intended to make the computer as available for programming as the television. A primary application would be to provide full movies and videos of various types of entertainment such as appear on television provided with commercial breaks. Just as commercials pay for television, they could be made to pay for this type of programming on computers. The regular programming offered for PCs/Internet appliances, set top boxes, and portable devices could be essentially of the same type as viewed on television and it could be presented for a fee to subscribers or presented entirely free to anyone who has a computer and access to the Internet. The programming is envisioned to be twenty-four hours a day, 365 days a year. The program can be any type of presentation whether entertainment, such as movies, sporting events, or any programs of the sort presented on television whether a single production or a series, or instructional material. This list is not intended to be limiting. For example, any type of programming that could be presented in audio/video format could be used. Revenue to the web sites offering such programming is supplied through the commercial material inserted in the programming. These multimedia programs are downloadable, such as occurs at free music sites and radio sites that enable the consumer to create a play list on their computers. Unlike television, it is optional to provide that, when a commercial is airing, the consumer will be able to double-click on the commercial and go right into the web site of the advertiser of the particular product or service shown. This creates Instant Product Purchase (I.P.P.) in the course of a program which is being performed on a scheduled and regular continuous basis. Hence, a product or service advertised in the course of programming can be investigated and purchased directly from the screen using a mouse or other means of activating a link to the sales web site of the advertiser. Completing a sale can then be done in a known manner as provided at various web sites.

More specifically, the present invention relates to the method of preparing and integrating media and other compatible material for presentation as a program of set length in time for use at a web site on the Internet as regular pre-set programming. This method involves capturing and defining movie and commercial footage of selected advertisers on a memory device. During capture of the program the process permits encoding on the program predetermined custom enhancements of both audio and video. These enhancements can be accomplished for all programming to provide improved audio and video quality within acceptable band width constraints imposed by the Internet and any equipment that must be used therewith. For example, the audio may be separately processed to adjust the sound level. The audio and video components have running time adjusted to fit within a standard program time interval. The format of the commercial content is encoded in post-processing to match the setting used on the movie content. The finalized content is transmitted to the distribution server. The finalized content is arranged into final programming format, for example, consisting of individual movie content files interspersed with commercial content files using a side server play and sequence list. The system is then prepared for uninterrupted broadcast using the side server play list to put the movies in predetermined sequence. The movies as sequenced are then made accessible to subscribers at scheduled times from a designated source.

The designated source is a specified web site which client computers may reach. If access is for pay, the computer may be provided with the required access code to trigger the designated site or have unscrambling means if programming provided is scrambled. The computer will then receive programming being played according to a published schedule at the web site at the time of access.

### BRIEF DESCRIPTION OF THE DRAWINGS

For a better understanding of the present invention, reference is made to the accompanying drawings in which

FIG. 1 is a process diagram showing how commercial footage, such as advertisements are processed;

FIG. 2 is a similar diagram showing how programming, such as a movie, is processed;

FIG. 3 is a continuation of the process diagrams showing how the processed programming and commercial footage is merged and prepared for broadcast.

### DETAILED DESCRIPTION OF THE INVENTION

The present invention relates to multimedia programming for the Internet. In accordance with the invention a movie, video, or other pre-existing form of entertainment from whatever kind of media is put into the system to be merged with commercials. The commercials, of course, need not be commercials, as such, but may be public service announcements or other types of messages which periodically interrupt the entertainment or other programming portion of the program. In accordance with the present invention, the pre-existing or specially created movie, video, or other programming in whatever its initial existing form, is played on an appropriate player and transformed into an appropriate signal to be input to a processing system in which it is prepared for the programming desired by the producers. The process produces a program of predetermined length which can be inserted into a regularly scheduled broadcast or program originating from a web site. The programs may be made available all day and all night if desired, or for any period of time through the day that is provided for. The objection is to have a web available program which is like television in that it runs continuously so that a user must access the web site at the scheduled time for the beginning of a particular program he desires to see. The schedules can then be printed and distributed and published on television and the web. The programming may be made available free to the public, in which case access to the web site is available to anyone wishing to access it from a computer who knows the web address. In such cases the programming is paid for by the advertisers. However, the quality may be better than what is broadcast, or at least a quality of programming on cable television supplied over the line by a local distributor. A local distributor usually has a monopoly in a given community and exacts a fee from the recipient. Another television choice is obtaining programming, again for a fee, by a satellite distributor from a dish antenna installed by the distributor. In the situation of the present invention, however, if the access is provided free, a high quality image can be transmitted from a web site to a computer monitor and both the image on the monitor and the sound can be superior to what may be obtained over the air.

The possibility exists, of course, for some web sites to elect to charge a fee for their programming and to have encoded web site access similar to encoding recently done by certain television channels.

The drawings are intended to illustrate a particular embodiment of the invention in which programming (e.g. movie) footage and commercial footage in some conventional form are put into an appropriate player for the type of media used and processed to produce to output signals of a conversion type which is then processed and merged.

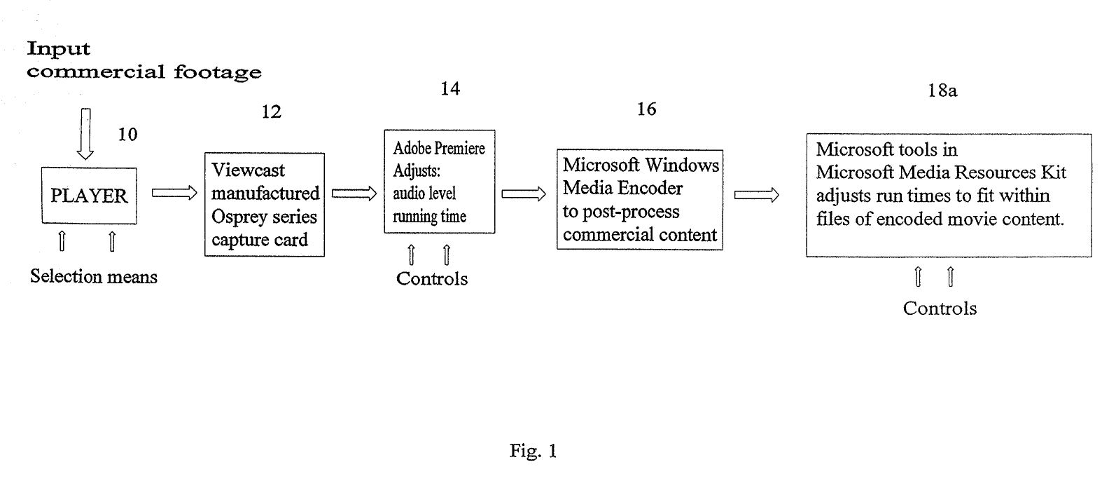

As seen in FIG. 1, commercial footage is input into an appropriate player 10, which as appropriate, for example, may be a video cassette player or a digital image generator and which provides an output converted to an appropriate form for the Internet which can be used by a suitable capturing means 12. In the diagram showing the process, by way of example, an Osprey series capture card by Viewcast is shown. In the process as illustrated, commercially available equipment and processes are used to show feasibility, but it will be understood, by those in the art that there are competitive devices which can be used to capture, improve and prepare the material input into the system. In this case, the Osprey series capture card receives the signal input in a form which can be handled by the computer software used for processing. The audio level and the running time are next adjusted, for example by Adobe Premiere Software 14 which permits adjustments by programmers using external controls. Assuming that the commercial material is on a movie format, the movie content is then encoded following the capture process, for example, using Microsoft Media Encoder 16 to post-process a commercial content from the capture card. The Windows Media Encoder may provide predetermined custom enhancements for both audio and video which are predetermined to be desirable for all programming to provide improved audio and video quality within acceptable band constraints imposed by the Internet and the equipment that must be used therewith. This processing is normally done using custom settings, such as frame size, frame rate, compression ratio, and video codec, which accomplish the desired results. Although human intervention might be possible, and means for providing it may be included, automated programming may usually suffice for this step. Since this content is commercial, the advertiser may wish the content adjusted in certain ways that may be better controlled by a human operator with adjustment controls to the system beyond those custom adjustments. The program adjusts run times, it can split the commercial material into sub-divided files, but normally is used to fine adjust the run time of the commercial material to fit within the individual movie files and provide transition time between the commercial and the movie.

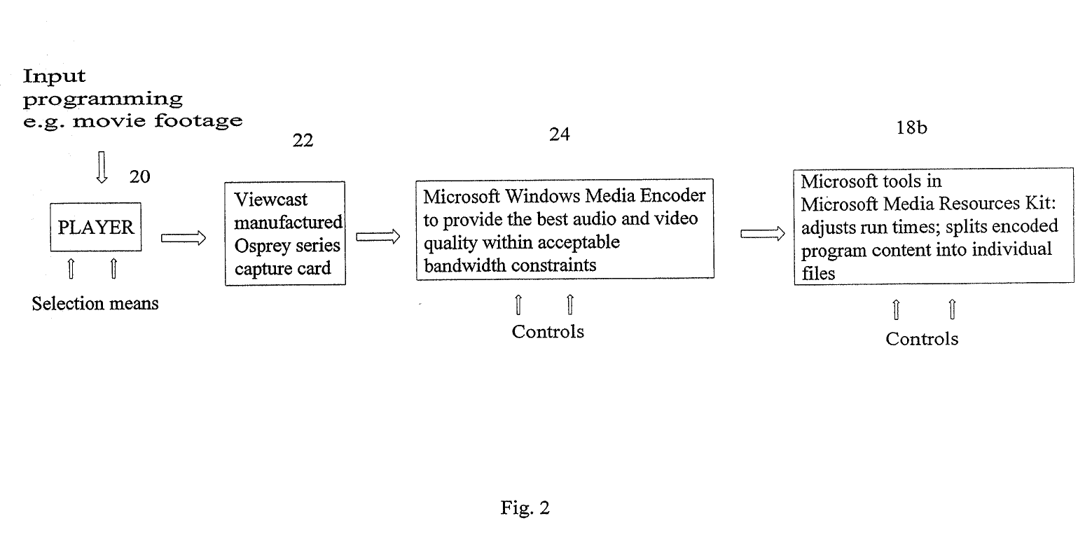

FIG. 2 shows processing of programming, e.g. movie footage which is input into a suitable player 20 which provides an output compatible with the output form commercial footage player 10 of FIG. 1. The process of FIG. 2 may be acting in parallel or sequentially with the commercial footage input. Each can be independent of the other processing but often both are produced using some but not all of the same programming and adding programming appropriate to its process. Its output is also captured by means 22, which, for example, may be a Viewcast manufactured Osprey Series Capture Card, or its equivalent or alternative. This may be the same as capture card 12 in FIG. 1 if desired, but the output of each capture card, in any event, must be compatible with the other. The Microsoft Media Encoder may be used again provided to produce the best audio and video quality within acceptable bandwidth constraints. However, programmers who must also keep system limitations in mind may, if desirable, be involved. The program (movie) footage processed is then processed by Microsoft tools software 18b in Microsoft Media Resources Kit. Next, Microsoft tools and the Microsoft Media Resources Kit, for example, may be the means 18b provided to adjust run times and split the encoded movie content into individual files in accordance with the judgement of the human programmer. The relevant encoding format and settings, e.g. frame size, frame rate, compression ratio, video codec selection, etc., are chosen to match those of the commercial content. Alternatively, the settings for encoding commercial content are chosen to match those of the programming contents.

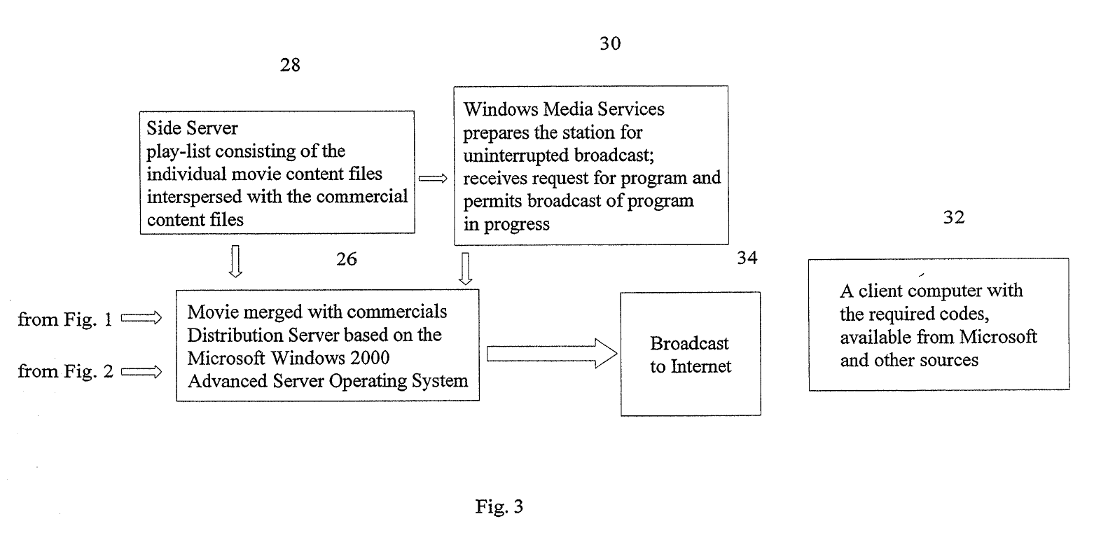

FIG. 3, shows the process for merging and distributing the merged entertainment and commercial product. Distribution server 26 is based, for example, on the Microsoft Windows 2000 Advanced Server Operating System. It effectively merges the inputs from the processes of FIGS. 1 and 2 under the control of the Side Server 28. Side Server 28 uses the play list supplied by the human programmer. The play list consists of the individual movie content files interspersed with the commercial content files. Then Windows Media Services 30 prepares the Internet station for uninterrupted broadcast with the programming for each day as set in place by the side server 28. In addition to preparing the station at the web site for uninterrupted broadcast, it receives request for a computer to connect to the website and permits broadcast of the program in progress.

A client computer 32 then may access the web site for the desired set programming. The client computer 32 may be a conventional computer or one equipped with required codecs or able to access required codecs available from Microsoft and other sources. If required codecs are installed on the client computer 32 they will be recognized by Windows Media Service 30 at the web site and permit the broadcast of program in progress to that computer. If access is not limited, the medium 34 for broadcast to the Internet allows the program to be received by the client computer 32 upon that computer accessing the web site.

It will be understood by those skilled in the art as suggested above that different types of processing software from that disclosed may be used to achieve the desired results of the present invention. Such software is readily available on the market maybe assembled as desired for the purpose of the invention. Substituted software and equivalent processing steps are intended to be within the scope of the present invention.

We claim:

1. A method of preparing, assuring compatibility and integrating programming media and other commercial material for presentation as a composite program of set length of time for use at a web site on the Internet, comprising:
capturing and defining programming and commercial footage on a memory device;
encoding programming and commercial material with predetermined custom enhancements of both audio and video which are predetermined to be desirable for all programming to provide improved audio and video quality within acceptable bandwidth constraints imposed by the Internet and equipment that must be used therewith;
adjusting audio and video running time to fit within standard program format;
encoding the commercial content in post processing to match the setting used on programming content;
splitting the encoded programming content into individual files;
transmitting finalized content to a distribution server, and
arranging the finalized content into final program format, consisting of individual programming content files interspersed with selected commercial content files, using a side server play list.

2. A method of preparing, assuring compatibility and integrating programming media and other commercial material for presentation as a composite program of set length of time for use at a web site on the Internet, comprising:
capturing and defining programming and commercial footage on a memory device;
encoding programming and commercial material with predetermined custom, enhancements of both audio and video which are predetermined to be desirable for all programming to provide improved audio and video quality within acceptable bandwidth constraints imposed by the Internet and equipment that must be used herewith;
reprocessing audio to adjust sound level;
adjusting audio and video running time to fit within standard program format;
encoding the commercial content in post processing to match the setting used on programming content;
splitting the encoded programming content into individual files;
transmitting finalized content to distribution server;
arranging the finalized content into final program format, consisting of individual programming content files interspersed with selected commercial content files, using a side server play list;
preparing the system for uninterrupted broadcast using the side server play list to put programming in predetermined sequence, and
making composite program as sequenced accessible to subscribers at scheduled times at a designated source.

3. The process of claim 1 in which client computers are provided with required code access designated source and are thereby able to receive coded programming being played at the time of access according to published schedule.

4. A method of delivering multimedia content via a computer network, comprising:
encoding programming content into a digital form according to a selected encoding parameter;
encoding advertising content into the digital form according to the selected encoding parameter;
merging the programming content and the advertising content into a merged sequence;
storing the merged sequence on a server connected with the network;
transmitting the merged sequence to a client computer connected with the network upon receipt of a request to receive the merged sequence, commencing at a position within the sequence determined by a time of receipt of the request and a predetermined transmission schedule.
